(19) United States
(12) Patent Application Publication
(10) Pub. No.: US 2025/0209774 A1
(43) Pub. Date: Jun. 26, 2025

(54) MONITORING CAMERA SYSTEM, RADIATION IMAGING SYSTEM, AND METHOD

(71) Applicants: Canon Kabushiki Kaisha, Tokyo (JP); CANON MEDICAL SYSTEMS CORPORATION, Tochigi (JP)

(72) Inventors: Toru SASAKI, Yokohama (JP); Risa NAKASHIMA, Utsunomiya (JP); Haruki IWAI, Otawara-shi (JP)

(73) Assignees: Canon Kabushiki Kaisha, Tokyo (JP); CANON MEDICAL SYSTEMS CORPORATION, Tochigi (JP)

(21) Appl. No.: 18/985,450

(22) Filed: Dec. 18, 2024

(30) Foreign Application Priority Data
Dec. 22, 2023 (JP) 2023-217043

(51) Int. Cl. G06V 10/22; G06V 10/24; G06V 10/25; G06V 10/82

(52) U.S. Cl. CPC G06V 10/225; G06V 10/245; G06V 10/25; G06V 10/82; G06V 2201/034

(57) ABSTRACT

A monitoring camera system according to an embodiment includes processing circuitry configured: to acquire camera image data obtained by a camera installed in an examination room and configured to image an environment including a medical apparatus with which it is possible to place an examined subject; to generate display image data on a basis of the camera image data; and to cause a display to display the display image data. The processing circuitry is configured: to estimate a placement region corresponding to a region in which the examined subject is placed in the camera image data; to generate corrected image data obtained by correcting the camera image data in accordance with the placement region; to estimate a region representing the examined subject and being included in the corrected image data; and to generate the display image data on the basis of the corrected image data and the region representing the examined subject.

### CROSS-REFERENCE TO RELATED APPLICATIONS

This application is based upon and claims the benefit of priority from Japanese Patent Application No. 2023-217043, filed on Dec. 22, 2023; the entire contents of which are incorporated herein by reference.

### FIELD

Embodiments described herein relate generally to a monitoring camera system, a radiation imaging system, and a method.

### BACKGROUND

Among medical apparatuses configured to acquire a medical image or to perform treatment for an examined subject (hereinafter, “patient”), there are certain types of apparatuses with which it is possible to place the patient. For example, a medical apparatus includes a tabletop (or a couchtop) provided over a table (or a couch) and is configured to perform image acquisition or treatment for a patient placed on the tabletop (couchtop). On such occasion, to check a positional relationship between the medical apparatus and the patient or a state of the patient, a camera installed in the examination room is used for monitoring the patient.

### BRIEF DESCRIPTION OF THE DRAWINGS

FIG. 1 is a block diagram illustrating an exemplary configuration of a system according to a first embodiment;

FIG. 2 is a diagram illustrating an example of the system according to the first embodiment;

FIG. 3 is a flowchart illustrating an example of a procedure in a display image data generating process according to the first embodiment;

FIG. 4 is a drawing illustrating an example of positioning of a tabletop and a patient in camera image data according to the first embodiment;

FIG. 5 is a drawing illustrating examples of a mask and a tabletop edge polygon calculated with respect to the camera image data according to the first embodiment;

FIG. 6 is a drawing illustrating an example of a tabletop extracted region according to the first embodiment;

FIG. 7 is a diagram illustrating an example of a system according to a second embodiment;

FIG. 8 is a flowchart illustrating an example of a procedure in a camera posture measuring process according to the second embodiment;

FIG. 9 is a drawing for explaining reference coordinate values according to the second embodiment;

FIG. 10 is a flowchart illustrating an example of a procedure in a display image data generating process according to the second embodiment;

FIG. 11 is a diagram illustrating an example of a system according to a third embodiment;

FIG. 12 is a drawing illustrating a display example of a patient check screen according to a fourth embodiment;

FIG. 13 is a drawing illustrating another display example of the patient check screen according to the fourth embodiment;

FIG. 14 is a drawing illustrating an example of a layout setting screen according to the fourth embodiment;

FIG. 15 is a drawing illustrating another example of the layout setting screen according to the fourth embodiment; and

FIG. 16 is a drawing illustrating an example of a screen displayed when a composite layout tab is selected according to the fourth embodiment.

### DETAILED DESCRIPTION

A monitoring camera system according to an embodiment includes processing circuitry configured: to acquire camera image data obtained by a camera installed in an examination room and configured to image an environment including a medical apparatus with which it is possible to place an examined subject; to generate display image data on a basis of the camera image data; and to cause a display to display the display image data. The processing circuitry is configured: to estimate a placement region corresponding to a region in which the examined subject is placed in the camera image data; to generate corrected image data obtained by correcting the camera image data in accordance with the placement region; to estimate a region representing the examined subject and being included in the corrected image data; and to generate the display image data on the basis of the corrected image data and the region representing the examined subject.

Exemplary embodiments of a monitoring camera system, a radiation imaging system, and a method will be explained below, with reference to the accompanying drawings. In the following embodiments, some of the elements referenced by using the same reference characters are assumed to perform mutually the same operations, and duplicate explanations thereof may be omitted as appropriate.

### First Embodiment

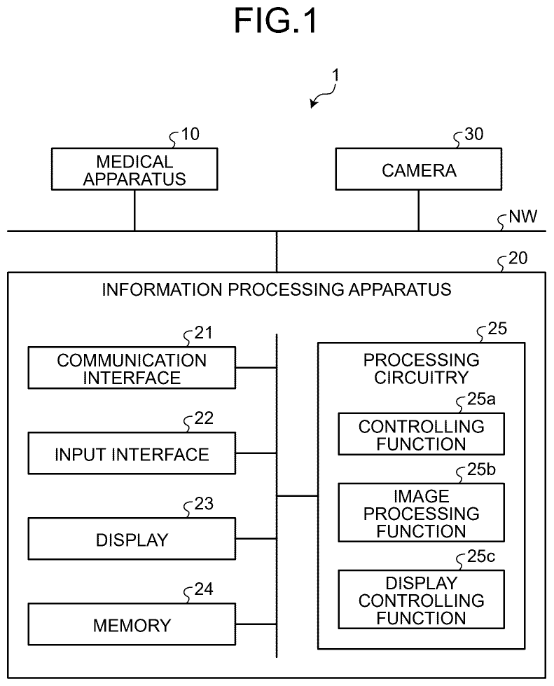

In a first embodiment, a system 1 in FIG. 1 will be explained as an example. The system 1 includes a medical apparatus 10, an information processing apparatus 20, and a camera 30. The medical apparatus 10, the information processing apparatus 20, and the camera 30 are communicably connected via a network NW.

The medical apparatus 10 is an apparatus provided in an examination room and configured to acquire a medical image and/or to perform treatment for an examined subject (hereinafter, “patient”). Examples of the medical apparatus 10 include: radiation diagnosis apparatuses such as an X-ray diagnosis apparatus, a Computed Tomography (CT) apparatus, a Positron Emission computed Tomography (PET) apparatus, and a Single Photon Emission Computed Tomography (SPECT) apparatus; and medical image diagnosis apparatuses such as a Magnetic Resonance Imaging (MRI) apparatus. Other examples of the medical apparatus 10 include treatment apparatuses such as a radiation treatment apparatus. The medical apparatus 10 is configured to perform the medical image acquisition and/or the treatment for the patient placed on a tabletop or a couchtop (hereinafter, simply “tabletop”) or a table or a couch (hereinafter, simply “table”). In other words, the medical apparatus 10 is configured so that it is possible to place the patient therewith.

The information processing apparatus 20 is an apparatus configured to generate display image data on the basis of camera image data obtained by the camera 30 and to cause a display to display the display image data. For example, as illustrated in FIG. 1, the information processing apparatus 20 includes a communication interface 21, an input interface 22, a display 23, a memory 24, and processing circuitry 25.

The communication interface 21 is configured to control transfer of various types of data and communication transmitted and received between the information processing apparatus 20 and other apparatuses and systems connected thereto via the network NW. More specifically, the communication interface 21 is connected to the processing circuitry 25 and is configured to output the data received from the other apparatuses and systems to the processing circuitry 25, and to transmit the data output from the processing circuitry 25 to any of the other apparatuses and systems. For example, the communication interface 21 may be realized by using a network card, a network adaptor, or a Network Interface Controller (NIC).

The input interface 22 is configured to receive various types of input operations from a user, to convert the received input operations into electrical signals, and to output the electrical signals to the processing circuitry 25. For example, the input interface 22 may be realized by using a mouse, a keyboard, a trackball, a switch, a button, a joystick, a touchpad on which input operations can be performed by touching an operation surface thereof, a touch screen in which a display screen and a touchpad are integrally formed, contactless input circuitry using an optical sensor, audio input circuitry, and/or the like. Alternatively, the input interface 22 may be configured by using a tablet terminal or the like capable of wirelessly communicating with a main body of the information processing apparatus 20. Further, the input interface 22 may be circuitry configured to receive input operations from the user via motion capture. In an example, the input interface 22 is able to receive, as the input operations, a body movement, a line of sight, and/or the like of the user, by processing a signal obtained via a tracker or an image acquired of the user. Further, the input interface 22 does not necessarily need to include physical operation component parts such as the mouse, the keyboard, and/or the like. For instance, possible examples of the input interface 22 include electrical signal processing circuitry configured to receive an electrical signal corresponding to an input operation from an external input mechanism provided separately from the information processing apparatus 20 and to output the electrical signal to the processing circuitry 25.

The display 23 is configured to display various types of information. For example, the display 23 is configured to display a Graphical User Interface (GUI) used for receiving various types of instructions and settings from the user, via the input interface 22. Further, the display 23 is configured to display a combined image (explained later). For example, the display 23 may be a liquid crystal display or a Cathode Ray Tube (CRT) display. The display 23 may be of a desktop type or may be configured by using a tablet terminal or the like capable of wirelessly communicating with the main body of the information processing apparatus 20.

The memory 24 is realized by using a semiconductor memory element such as a Random Access Memory (RAM) or a flash memory, or a hard disk, an optical disc, or the like. For example, the memory 24 has stored therein various types of image data and programs used by circuitry included in the information processing apparatus 20 for realizing functions thereof. In an example, the memory 24 may be realized by using a server group (a cloud) connected to the information processing apparatus 20 via the network NW.

The processing circuitry 25 is configured to control operations of the entirety of the information processing apparatus 20 by functioning as a controlling function 25a, an image processing function 25b, and a display controlling function 25c. For example, the processing circuitry 25 is configured to function as the controlling function 25a, by reading and executing a program corresponding to the controlling function 25a from the memory 24. Similarly, the processing circuitry 25 is configured to function as the image processing function 25b and the display controlling function 25c. The image processing function 25b is an example of an image processing hu. The display controlling function 25c is an example of a display controlling unit. Details of processes performed by the processing circuitry 25 will be explained later.

In the information processing apparatus 20 illustrated in FIG. 1, processing functions are stored in the memory 24 in the form of computer-executable programs. The processing circuitry 25 is a processor configured to realize the functions corresponding to the programs, by reading and executing the programs from the memory 24. In other words, the processing circuitry 25 that has read the programs has the functions corresponding to the read programs.

Although the example was explained with reference to FIG. 1 in which the single piece of processing circuitry (i.e., the processing circuitry 25) realizes the controlling function 25a, the image processing function 25b, and the display controlling function 25c, it is also acceptable to structure the processing circuitry 25 by combining together a plurality of independent processors, so that the functions are realized as a result of the processors executing the programs. Further, the processing functions of the processing circuitry 25 may be realized as being distributed among or integrated into one or more pieces of processing circuitry.

Further, the processing circuitry 25 may be configured to realize the functions by using a processor of an external apparatus connected thereto via the network NW. For example, the processing circuitry 25 may be configured to realize the functions illustrated in FIG. 1, by reading and executing the programs corresponding to the functions from the memory 24, while using a server group (a cloud) connected to the information processing apparatus 20 via the network NW, as a computation resource.

The camera 30 is installed in the examination room and is configured to image an environment including the medical apparatus 10 with which it is possible to place the patient. In this situation, the environment including the medical apparatus 10 denotes a range including at least a part of the medical apparatus 10. For example, as the environment including the medical apparatus 10, the camera 30 may image a range including the tabletop provided for the medical apparatus 10 and the patient placed on the tabletop. For example, the camera 30 is installed on a wall surface or the ceiling of the examination room.

Among the elements in the system 1 illustrated in FIG. 1, the information processing apparatus 20 and the camera 30 structure a monitoring camera system. The monitoring camera system structured with the information processing apparatus 20 and the camera 30 is configured to assist an operator in monitoring the patient subject to the image acquisition and/or the treatment performed by the medical apparatus 10, by generating and presenting the display image data of the patient for the operator of the medical apparatus 10.

An example of an overall configuration of the system 1 has thus been explained. Next, a more specific example of the system 1 will be explained, by using a situation where a radiation diagnosis apparatus is included therein as the medical apparatus 10. The system 1 in the situation where a radiation diagnosis apparatus is included as the medical apparatus 10 may be referred to as a radiation imaging system.

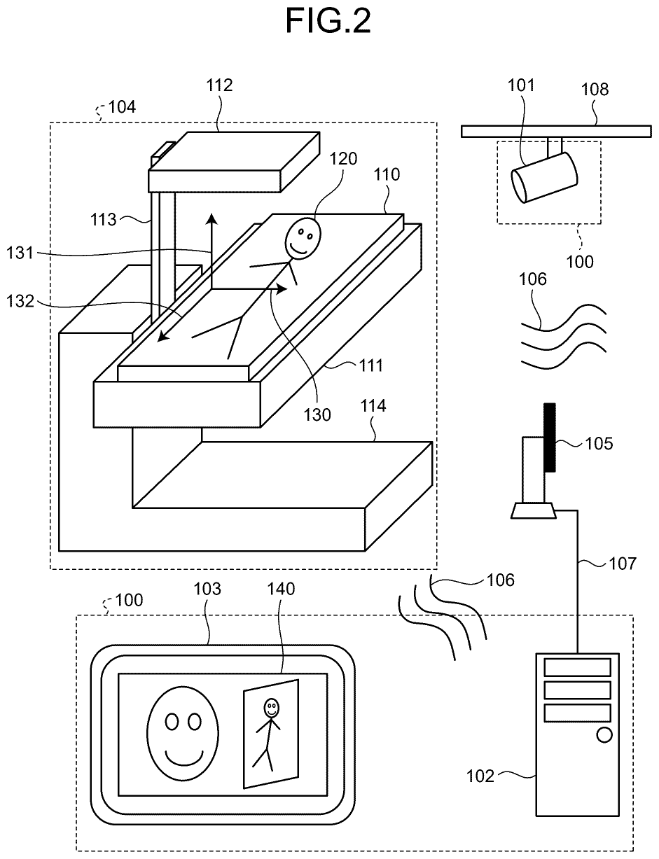

FIG. 2 is a diagram illustrating an example of the system 1 according to the first embodiment. The system 1 in FIG. 2 includes an Internet Protocol (IP) camera 101, an image processing apparatus 102, a tablet PC 103, and a radiation diagnosis apparatus 104.

Among the various types of constituent elements illustrated in FIG. 2, the IP camera 101, the image processing apparatus 102, and the tablet PC 103 structure a monitoring camera system 100. The monitoring camera system 100 is configured to provide assistance in monitoring a patient 120, by generating and presenting, for an operator of the radiation diagnosis apparatus 104, display image data of the patient 120 subject to image acquisition performed by the radiation diagnosis apparatus 104.

The IP camera 101 is an example of the camera 30. The IP camera 101 is a network camera that is provided with an Internet Protocol (IP) and capable of performing data communication via a network. For example, after the monitoring camera system 100 is started up, the IP camera 101, the image processing apparatus 102, and the tablet PC 103 connect to a network 106 via a wireless network hub 105 and are thus able to communicate with one another. For example, the IP camera 101 is fixed to a ceiling 108 of an examination room, so as to image an environment including the radiation diagnosis apparatus 104.

The radiation diagnosis apparatus 104 to be imaged by the IP camera 101 will be explained. The radiation diagnosis apparatus 104 includes a tabletop 110, a table 111, and a radiation (X-ray) tube 112. Although FIG. 2 illustrates an X-ray TV apparatus as an example of the radiation diagnosis apparatus 104, possible embodiments are not limited to this example. For instance, the present disclosure is also applicable to other types of radiation diagnosis apparatuses such as an X-ray angiography apparatus. The X-ray TV apparatus may be used in an examination of the upper digestive tract, for example.

In FIG. 2, the patient 120 is placed over the table 111 and the tabletop 110, while lying down (in a decubitus position) along the longitudinal direction (a tabletop coordinate system z-axis 132) of the tabletop 110. The tabletop 110 is movable over the table 111 along a tabletop coordinate system x-axis 130. Further, the radiation (X-ray) tube 112 and a support pillar 113 are movable along a tabletop coordinate system y-axis 131 and the tabletop coordinate system z-axis 132. Further, by integrally rotating around the tabletop coordinate system x-axis 130, the tabletop 110, the table 111, the radiation (X-ray) tube 112, and the support pillar 113 are capable of changing the posture of the patient 120 from the lying posture (the decubitus position) into a standing posture (a standing position).

As explained herein, the radiation diagnosis apparatus 104 includes the plurality of movable parts and is capable of making various movements. Further, at the time of causing the movable parts to make those movements, it is desirable that the operator of the radiation diagnosis apparatus 104 ensures safety by predicting behaviors of the patient 120 while looking at his/her state. Further, regardless of whether or not the movable parts are making the movements, it is desirable that the operator checks the state of the patient 120. For example, in the situation where an endoscope is inserted for the patient 120 placed on the tabletop 110, it is desirable to check facial expressions of the patient 120, because the insertion of the endoscope may cause emesis.

However, it would not be easy for the operator of the radiation diagnosis apparatus 104 to directly monitor the patient 120. For example, because the radiation diagnosis apparatus 104 and other examination equipment are disposed around the patient 120, it might be difficult to check on the patient 120 from where the operator is positioned. In addition, there may be a situation where a plurality of medical providers such as a doctor and a nurse are in the examination room, which would make it difficult to check on the patient 120 because the operator's view might be blocked by the medical providers. Furthermore, when the operator is in a control room outside the examination room, it might be even more difficult to check on the patient 120.

To cope with the circumstances described above, the monitoring camera system 100 is configured to provide assistance in efficiently monitoring the patient 120, by generating and presenting the display image data for the operator.

An outline of processes is as follows: The monitoring camera system 100 is configured to generate the display image data on the basis of camera image data obtained by imaging the environment including the radiation diagnosis apparatus 104 and to cause a display to display the display image data. For example, the IP camera 101 is configured to obtain the camera image data taken with an angle of view including the radiation diagnosis apparatus 104 and to transmit the obtained camera image data for each frame to the image processing apparatus 102. The image processing apparatus 102 is configured to generate the display image data from the camera image data transmitted thereto. For example, in the situation where the head of the patient 120 needs to be monitored such as when the patient 120 has the possibility of having emesis, the image processing apparatus 102 is configured to detect the tabletop 110 and the head of the patient 120 and to generate display image data by extracting and combining detected sections together. The display image data is transmitted to the tablet PC 103 for each frame so as to be displayed on a display 140. With this configuration, the operator of the radiation diagnosis apparatus 104 is able to operate the radiation diagnosis apparatus 104, while checking on the state of the patient 120 by looking at the display 140.

In FIG. 2, the image processing apparatus 102 includes processing circuitry and is thus capable of executing an image processing function similarly to the processing circuitry 25 illustrated in FIG. 1. In other words, the image processing function of the image processing apparatus 102 is configured to generate the display image data, on the basis of the camera image data obtained by the IP camera 101. The image processing function of the image processing apparatus 102 is an example of an image processing unit.

Further, the display 140 included in the tablet PC 103 is an example of the display. The tablet PC 103 includes processing circuitry and is capable of executing a display controlling function similarly to the processing circuitry 25 illustrated in FIG. 1. In other words, the display controlling function of the tablet PC 103 is configured to cause the display 140 to display the display image data generated by the image processing apparatus 102. The display controlling function of the tablet PC 103 is an example of a display controlling unit. The combination of the image processing apparatus 102 and the tablet PC 103 illustrated in FIG. 2 is an example of the information processing apparatus 20.

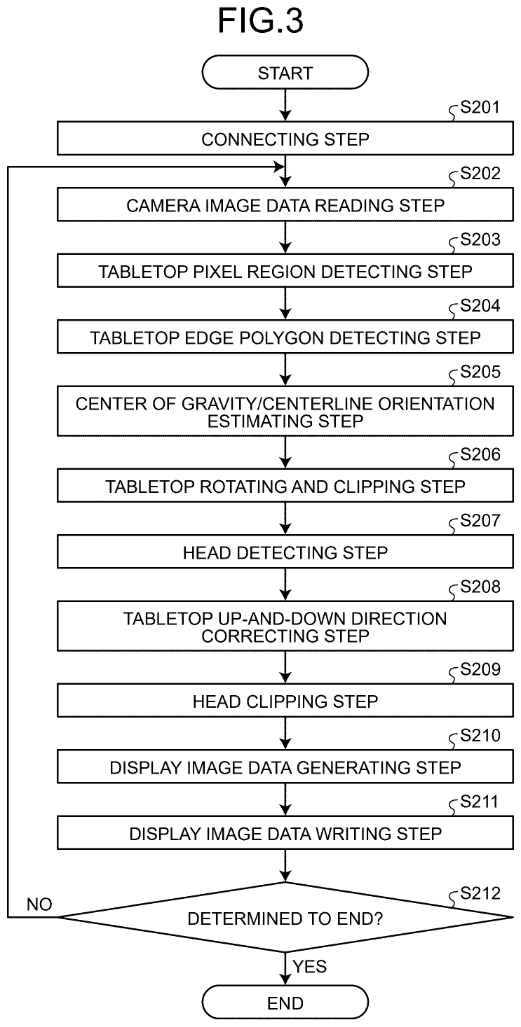

The image processing apparatus 102 is configured to generate the display image data, on the basis of the camera image data obtained by the IP camera 101 (the camera 30). A procedure in a display image data generating process performed by the image processing apparatus 102 will be explained, with reference to FIG. 3. FIG. 3 is a flowchart illustrating an example of the procedure in the display image data generating process.

A connecting step S201 is a step for opening an input stream of the camera image data sent from the IP camera 101 and an output stream for transmitting the display image data to the tablet PC 103.

A camera image data reading step S202 is a step for reading the most recent camera image data from the input stream.

A tabletop pixel region detecting step S203 is a step for detecting, from the camera image data, a pixel region (hereinafter, “tabletop pixel region”) corresponding to the tabletop 110. In the flowchart in FIG. 3, the tabletop 110 is an example of a placement region corresponding to a region in which the patient 120 is placed. In other words, at the tabletop pixel region detecting step S203, the image processing apparatus 102 estimates the placement region. For example, at the tabletop pixel region detecting step S203, the image processing apparatus 102 detects the tabletop pixel region by using a Deep Neural Network (DNN). In other words, the placement region may be estimated by the Deep Neural Network. For example, as a result of the detection, the DNN is configured to output a binary image (hereinafter, a “mask”) in which the value of each of the pixels determined to correspond to the tabletop 110 is “1”, whereas the value of each of the other pixels is “0”.

At a tabletop edge polygon detecting step S204, a polygon (hereinafter, “tabletop edge polygon”) corresponding to a contour of the region in which the mask pixel values are “1” is estimated, so that vertex coordinates of the polygon are output. The tabletop edge polygon is information indicating the region corresponding to the contour of the region in which the mask pixel values are “1”. The tabletop edge polygon may also be called a tabletop edge region. For example, the polygon is obtained by detecting an edge of the mask through an image processing process and further carrying out a polyline approximation on the edge by using a “Ramer-Douglas-Peucker” algorithm or the like.

At a center of gravity/centerline orientation estimating step S205, average coordinates (hereinafter, “center of gravity”) of the pixels in the tabletop pixel region and a direction vector (hereinafter, “centerline orientation”) in the tabletop pixel region corresponding to the longitudinal direction of the tabletop are estimated. When there are N pixels each having the pixel value “1” in the mask, it is possible to express a center of gravity w with the coordinates “xi (where i=0, 1, . . . , and N−1)” of the pixels having the pixel value “1”, by using Expression (1) presented below.

$$w = \frac{{\sum }_{i = 0}^{N - 1} {x}_{i}}{N} \qquad ( 1 )$$

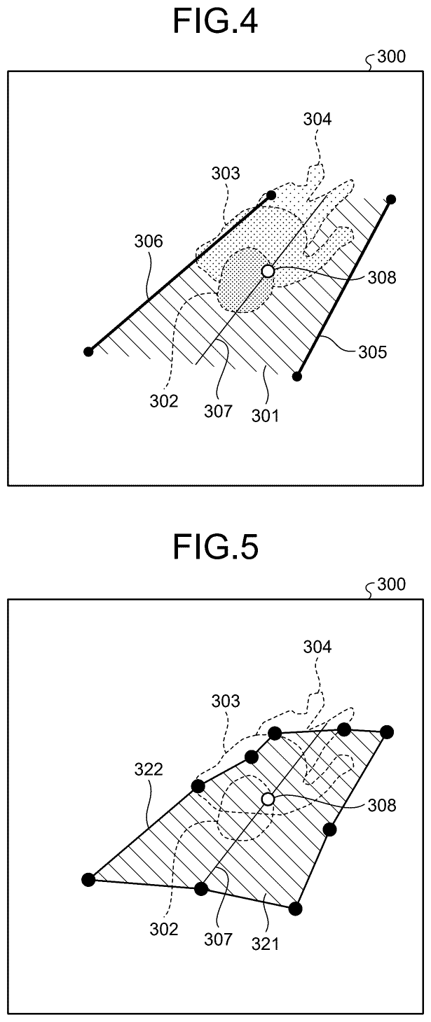

A definition of a centerline will be explained, with reference to FIG. 4. FIG. 4 is a drawing illustrating an example of positioning of the tabletop 110 and the patient 120 in camera image data 300. Although the tabletop 110 in a three-dimensional space is generally rectangular, keystone distortion may occur in the camera image data 300, due to an effect caused by diagonal imaging.

In the following sections, the tabletop 110 appearing in the camera image data 300 as a two-dimensional shape may be referred to as a tabletop 301. The tabletop 301 has a shape corresponding to the position of the IP camera 101 with respect to the tabletop 110. For example, when the IP camera 101 is positioned on a straight line that passes through the center of the tabletop 110 and is perpendicular to a placement face of the tabletop 110, the tabletop 301 appears as a rectangle. In another example, when the IP camera 101 is positioned on a plane that passes through the center of the tabletop 110 and is perpendicular to one of the four sides of the placement face of the tabletop 110, the tabletop 301 appears as a trapezoid. When neither of these classifications applies, the tabletop 301 appears as a quadrangle having no set of parallel sides. FIG. 4 depicts the tabletop 301 as a quadrangle having no set of parallel sides.

In addition, the patient 120 may also be affected by the diagonal imaging. For example, although the patient 120 is lying on the tabletop 110, the camera image data 300 in FIG. 4 has a composition in which the torso 303 and the feet 304 of the patient 120 are protruding from the edge of the tabletop 301.

As explained earlier, the tabletop 301 in FIG. 4 is distorted due to the effect of the keystone distortion, and the two sides (sides 305 and 306) corresponding to the longitudinal direction of the tabletop 110 are oriented in mutually-different directions. A centerline 307 of the tabletop 301 illustrated in FIG. 4 is a line that passes through a center of gravity 308 of the tabletop 301 and is oriented in an average direction of the side 305 and the side 306. An orientation along the centerline 307 may also be referred to as a centerline orientation.

Estimation of the centerline orientation will be explained, with reference to FIG. 5. FIG. 5 is a drawing illustrating examples of the mask and the tabletop edge polygon calculated with respect to the camera image data 300. In the camera image data 300, the edge of the tabletop 301 is partially hidden by the body of the patient 120. Because it is difficult to accurately estimate the pixels of the hidden tabletop, the shape of a region 321 having the mask pixel values “1” tends to be inaccurate. Further, due to image quality of the camera image data 300, an effect caused by distortion at the edges of a screen, or the like, a certain part of the edge of the tabletop 301 that is not hidden by the body of the patient 120 may not be extracted as a simple straight line, either. For these reasons, a tabletop edge polygon 322 is not a rectangle and is divided by a plurality of vertices. Thus, the two sides (the sides 305 and 306) extending in the longitudinal direction are rarely obtained without being affected. For example, in the example illustrated in FIG. 5, the tabletop edge polygon 322 is a nonagon, while the side 305 is approximated as a polyline having one vertex, whereas the side 306 is approximated as a polyline having two vertices.

Thus, from among the plurality of sides of the tabletop edge polygon 322, the image processing apparatus 102 is configured to select, on the basis of the lengths and the orientations, sides oriented similarly to the two sides (the sides 305 and 306) extending in the longitudinal direction and to determine an average of the two orientations as the centerline orientation. For example, from tabletop edge polygon 322 appearing as the nonagon in FIG. 5, the line segment closer to the viewer is selected from between the two line segments corresponding to the side 305, and also, the line segment closer to the viewer is selected from among the three line segments corresponding to the side 306, so as to determine an average of the directions of the two selected line segments, as the centerline orientation.

At a tabletop rotating and clipping step S206, the image processing apparatus 102 generates corrected image data obtained by correcting the camera image data 300 in accordance with the placement region. For example, the tabletop rotating and clipping step S206 is a step for rotating and extracting a part of the camera image data 300, so that the centerline orientation corresponds to the up-and-down direction, while the position of the center of gravity 308 of the mask is used as the center. The extracted pixel region will hereinafter be referred to as a tabletop extracted region, so as to be distinguished from the tabletop pixel region obtained at the time of detecting the tabletop. The tabletop extracted region is an example of the corrected image data. In other words, the image processing apparatus 102 may be configured to generate the corrected image data (the tabletop extracted region), by rotating the region including the placement region so that the centerline of the placement region corresponds to the up-and-down direction. That is to say, the rotation angle of the rotation at the time of generating the corrected image data is determined on the basis of the orientations of the sides of the polygon (the tabletop edge polygon 322) enclosing the placement region.

As for the size of the tabletop extracted region, an arbitrary size may be selected while the tabletop pixel region is contained. In other words, the image processing apparatus 102 may extract a range corresponding to the tabletop pixel region as the tabletop extracted region or may extract a range obtained by adding a surrounding region (a margin) to the tabletop pixel region as the tabletop extracted region. Further, the image processing apparatus 102 may rotate the tabletop extracted region extracted from the camera image data 300 so that the centerline orientation corresponds to the up-and-down direction or may extract the tabletop extracted region from the camera image data 300 that has been rotated.

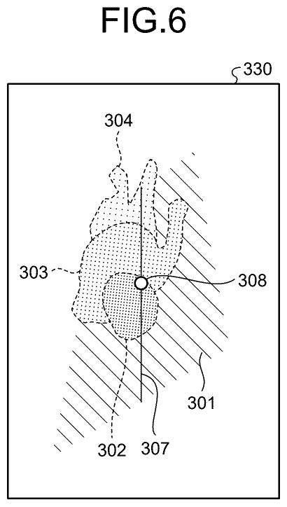

Characteristics of the tabletop extracted region will be explained with reference to FIG. 6. FIG. 6 illustrates a tabletop extracted region 330 as an example of the tabletop extracted region. The up-and-down direction of the tabletop extracted region 330 is a direction estimating the centerline 307. In other words, the tabletop extracted region 330 is image data obtained by rotating the region including the tabletop pixel region, so that the centerline 307 corresponds to the up-and-down direction. Although distortion remains, the tabletop 301 has a shape close to a bilaterally symmetric shape elongated lengthwise. Since the direction of the patient's crown (hereinafter, “the crown direction”) is not determined, the orientation may be upside down as illustrated in the example of FIG. 6.

A head detecting step S207 is a step for detecting the patient's head from the tabletop extracted region 330. In other words, at the head detecting step S207, the image processing apparatus 102 estimates a region representing the head of the patient 120 and being included in the tabletop extracted region 330. For example, at the head detecting step S207, the position and the size of the head are detected, by applying a head detection DNN to the tabletop extracted region 330.

Generally speaking, the more restrictive a conditions in input data is, the higher will be the precision level of a DNN. For example, a DNN configured to detect the head from image data of a patient in an upright posture exhibits a higher precision level for detecting the head than a DNN configured to detect the head from image data of the patient oriented in an arbitrary direction.

Because the crown direction is not determined in the tabletop extracted region 330, the image processing apparatus 102 is configured to detect the head from the tabletop extracted region 330, by using a DNN functioned to detect the head from image data of a patient in an upright posture or a headstand posture. Alternatively, the image processing apparatus 102 may detect the head from the tabletop extracted region 330 by using a DNN functioned to detect the head from image data of a patient in an upright posture and subsequently detect the head from the tabletop extracted region 330 rotated by 180 degrees by using the DNN again, so as to adopt a result having a higher evaluation value (accuracy) at the time of the detection. By using the tabletop extracted region 330 as the input to the DNN in this manner, it is possible to carry out the detection with a high level of precision, because the posture of the patient 120 is restricted to the upright posture (or the headstand posture), which is easily detected by the DNN.

At a tabletop up-and-down direction correcting step S208, the tabletop extracted region 330 is corrected as appropriate, so that the crown comes to the top. For example, when it is determined at the head detecting step S207 that the head is at the bottom, the image processing apparatus 102 rotates the tabletop extracted region 330 by 180 degrees. On the contrary, when it is determined at the head detecting step S207 that the head is at the top, the image processing apparatus 102 omits the correction of the tabletop extracted region 330 at the tabletop up-and-down direction correcting step S208.

At a head clipping step S209, a pixel region (hereinafter, “head extracted region”) centered on the position of the head is extracted from the tabletop extracted region 330. The image processing apparatus 102 may extract the region determined to be the head at the head detecting step S207 as the head extracted region or may extract a range obtained by adding a surrounding region (a margin) to the region determined to be the head as the head extracted region.

At a display image data generating step S210, the image processing apparatus 102 generates display image data on the basis of the corrected image data and a region representing the patient. For example, the image processing apparatus 102 may generate the display image data in which the camera image data, the tabletop extracted region, and the head extracted region are combined together and laid out as a single piece of image data. The pieces of image data may also be combined together after the sizes or the angles thereof are changed.

The tabletop extracted region used at the display image data generating step S210 may be the tabletop extracted region extracted at the tabletop rotating and clipping step S206 or may be a region separately extracted for the purpose of generating the display image data. For example, at the tabletop rotating and clipping step S206, the perimeter of the tabletop may be clipped out, to avoid erroneous recognition of the medical doctor or the nurse present in the surroundings. In that situation, the image processing apparatus 102 may re-generate a tabletop extracted region having a different size, for use in the generation of display image data.

At a display image data writing step S211, the display image data is written into the output stream. For example, the tablet PC 103 may cause the display 140 to display the display image data.

Further, at an end judging process S212, it is judged whether or not the display image data generating process is to be stopped, according to an instruction from the user. When it is determined at the end judging process S212 that the display image data generating process is not to be stopped (the end judging process S212: No), the monitoring camera system 100 returns to the camera image data reading step S202 and performs the processes described above again. On the contrary, when it is determined that the display image data generating process is to be stopped (the end judging process S212: Yes), the monitoring camera system 100 ends the processes. In other words, the monitoring camera system 100 continues to generate display image data on the basis of the camera image data and to display the display image data, until an instruction to end the process is received from the user.

The flowchart illustrated in FIG. 3 is merely an example, and it is possible to apply various types of modifications thereto. For instance, the example was explained with reference to FIG. 3 in which the centerline 307 is obtained on the basis of the orientations of the sides of the polygon (the tabletop edge polygon 322) enclosing the placement region, so as to calculate the rotation angle for the tabletop rotating and clipping step S206 in accordance with the orientation of the centerline 307. However, the process of calculating the rotation angle does not necessarily need to be performed in all the frames of camera video data. For example, if the tabletop 110 has a pattern or a component part that can serve as a landmark, a center of gravity or a rotation angle calculated from a past frame may be fine-tuned, on the basis of a positional shift of the landmark. In an example, it is possible to calculate a rotation angle on the basis of a positional difference of a physical object included in common to a plurality of pieces of camera image data taken at mutually-different times. As a result, it is possible to omit the processes from the tabletop pixel region detecting process S203 through the center of gravity/centerline orientation estimation S205.

As explained above, the monitoring camera system 100 according to the first embodiment includes the IP camera 101, the image processing apparatus 102, and the tablet PC 103. The IP camera 101 is installed in the examination room and is configured to image the environment including the radiation diagnosis apparatus 104 with which it is possible to place the patient 120. The image processing apparatus 102 is configured to generate the display image data on the basis of the camera image data 300 obtained by the IP camera 101. Further, the tablet PC 103 is configured to cause the display 140 to display the display image data.

More specifically, the image processing apparatus 102 is configured to estimate the tabletop 110, as the placement region corresponding to the region in which the patient 120 is placed in the camera image data 300. Further, the image processing apparatus 102 is configured to generate the corrected image data by correcting the camera image data 300 in accordance with the estimated tabletop 110. For example, the image processing apparatus 102 is configured to generate the tabletop extracted region 330, by estimating the centerline orientation on the basis of a result of estimating the tabletop 110 and further rotating and extracting a part of the camera image data 300 so that the centerline orientation corresponds to the up-and-down direction. Further, the image processing apparatus 102 is configured to estimate the region representing the patient 120 and being included in the corrected image data. For example, the image processing apparatus 102 is configured to detect the position and the size of the head by applying the head detection DNN to the tabletop extracted region 330. After that, on the basis of the corrected image data and the region representing the patient 120, the image processing apparatus 102 is configured to generate the display image data.

With the configurations described above, the monitoring camera system 100 according to the first embodiment is able to provide the assistance in efficiently monitoring the patient. For example, the monitoring camera system 100 is capable of detecting the head of the patient 120, without being affected by changes in the posture of the patient 120 made by the radiation diagnosis apparatus 104 and is capable of presenting changes in facial expressions of the patient 120, for the operator of the radiation diagnosis apparatus 104.

Generally speaking, people rendered in image data used for training a DNN are often oriented in the same direction while the crown is at the top of the image data. In contrast, in the camera image data 300, although the doctor or the nurse may be standing upright in many situations, the posture of the patient 120 can vary and may be in a lying state (a decubitus position) in many situations. For this reason, if a DNN were simply applied to the camera image data 300, the patient 120 might not be detected properly.

Further, it may be possible, for example, to cause a DNN to learn possible postures that may be taken by a plurality of persons present in an examination room, by using image data obtained by a monitoring camera provided in the examination room, such as the IP camera 101. However, this method would require generating training data for each examination room, and workloads at the time of installing the monitoring camera system would significantly increase.

Further, it may be possible to detect a plurality of persons as disclosed in Patent Literature 1 (JP 7, 118, 666 B2), for example, by causing a monitoring camera to take reference image data while nobody is present, so as to detect the patient as a difference image between image data taken in the presence of the people and the reference image data. However, this method would require taking the reference image data again, when lighting or the monitoring camera becomes deteriorated over the course of time or examination equipment is moved.

In contrast, the monitoring camera system 100 according to the first embodiment is configured to detect the head, by applying the DNN to the corrected image data such as the tabletop extracted region 330 that has been rotated so that the centerline orientation of the tabletop 110 corresponds to the up-and-down direction. With this configuration, it is possible to enhance the precision level of the detection performed by the DNN, without increasing work such as the acquisition of the training data or the reference image data. It is therefore possible to present the display image data that is more appropriate and to thus provide assistance in efficiently monitoring the patient 120.

### Second Embodiment

In a second embodiment, an example will be explained in which the placement region is estimated by using information about the position and the posture of the camera.

Further, although the example was explained in the first embodiment in which the tabletop 110 is detected as the placement region, the following sections will describe an example in which the table 111 is detected as a placement region. In other words, the placement region in the first embodiment is the tabletop 110 of the medical apparatus 10, whereas the placement region in the second embodiment is the table 111 of the medical apparatus 10. Further, although the region representing the patient 120 to be detected from the corrected image data is not particularly limited, an example will be explained in which the hands of the patient 120 are to be detected from the corrected image data.

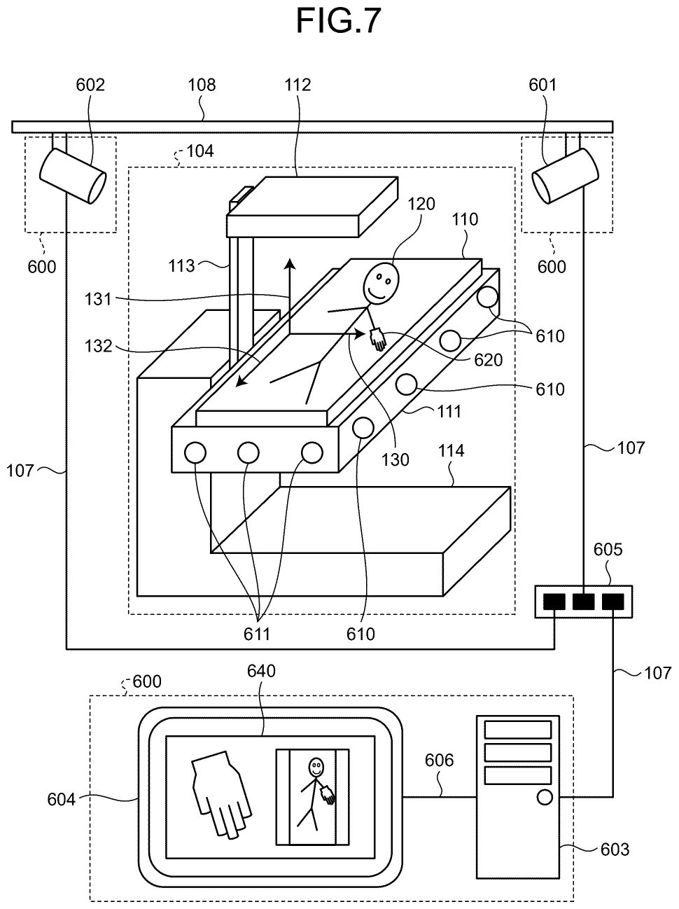

FIG. 7 is a diagram illustrating an example of the system 1 according to the second embodiment. The system 1 in FIG. 7 includes an IP camera 601, an IP camera 602, an image processing apparatus 603, a display 604, and the radiation diagnosis apparatus 104.

Among the various types of constituent elements illustrated in FIG. 7, the IP camera 601, the IP camera 602, the image processing apparatus 603, and the display 604 structure a monitoring camera system 600. The monitoring camera system 600 is configured to provide assistance in monitoring the patient 120, by generating and presenting, for the operator of the radiation diagnosis apparatus 104, display image data of the patient 120 subject to the image acquisition performed by the radiation diagnosis apparatus 104.

Similarly to the IP camera 101, the IP camera 601 and the IP camera 602 are each a network camera capable of performing data communication and each serve as an example of the camera 30. For example, the IP camera 601 and the IP camera 602 are fixed to the ceiling 108 of the examination room, so as to image an environment including the radiation diagnosis apparatus 104. For example, after the monitoring camera system 600 is started up, the IP camera 601, the IP camera 602, and the image processing apparatus 603 are able to communicate with one another, via a wired network hub 605. Further, the display 604 is connected to the image processing apparatus 603 by a display cable 606 and is configured to display images sent thereto from the image processing apparatus 603. The display 604 is an example of a display.

The radiation diagnosis apparatus 104 to be imaged by the IP camera 601 and the IP camera 602 is different from the radiation diagnosis apparatus 104 explained in the first embodiment in that markers 610 and markers 611 each having a spherical shape are attached to lateral faces of the table 111. In the following sections, the markers attached to a lateral face corresponding to a long side of the table 111 will be referred to as the markers 610, whereas the markers attached to a lateral face corresponding to a short side will be referred to as the markers 611. For example, the IP camera 601 is configured to image a range including the markers 610, as an environment including the radiation diagnosis apparatus 104. Also, the IP camera 602 is configured to image a range including the markers 611, as an environment including the radiation diagnosis apparatus 104.

An outline of processes is as follows: The IP camera 601 and the IP camera 602 are configured to obtain camera image data taken with an angle of view including the radiation diagnosis apparatus 104 and to transmit the obtained camera image data for each frame to the image processing apparatus 603. The image processing apparatus 603 is configured to generate the display image data from the camera image data transmitted thereto.

For example, at the time of moving the tabletop 110 along the tabletop coordinate system x-axis 130, it is desirable to arrange the hands of the patient 120 in prescribed positions, to prevent the hands of the patient 120 from being caught between the tabletop 110 and the table 111. More specifically, it is desirable to ensure that the hands of the patient 120 are in the state of being placed over the tabletop 110 or in the state of gripping handles provided on the tabletop 110. However, due to the patient 120 moving around, his/her hands may be shifted from the prescribed positions on the tabletop 110. For example, in some situations, a vinyl sheet may be placed between the tabletop 110 and the table 111, and the patient 120 may inadvertently grab the vinyl sheet.

As described above, when it is necessary to monitor the hands of the patient 120, the image processing apparatus 603 is configured to detect the tabletop 110 and the hands of the patient 120 from the camera image data transmitted thereto and to generate display image data obtained by extracting and combining detected sections together. The display image data for each frame is displayed on a display screen 640 of the display 604. With this configuration, the operator of the radiation diagnosis apparatus 104 is able to operate the radiation diagnosis apparatus 104, while checking on the state of the patient 120 by looking at the display 604. For example, the operator is able to move the tabletop 110 along the tabletop coordinate system x-axis 130 after confirming that the hands of the patient 120 will not be caught during the movement of the tabletop 110.

In FIG. 7, the image processing apparatus 603 includes processing circuitry and is capable of executing an image processing function and a display controlling function similarly to the processing circuitry 25 illustrated in FIG. 1. In other words, the image processing function of the image processing apparatus 603 is configured to generate the display image data on the basis of the camera image data obtained by the IP camera 601 and the IP camera 602. Further, the display controlling function of the image processing apparatus 603 is configured to cause the display to display the display image data. The image processing function of the image processing apparatus 603 is an example of an image processing unit. The display controlling function of the image processing apparatus 603 is an example of a display controlling unit. The image processing apparatus 603 is an example of the information processing apparatus 20.

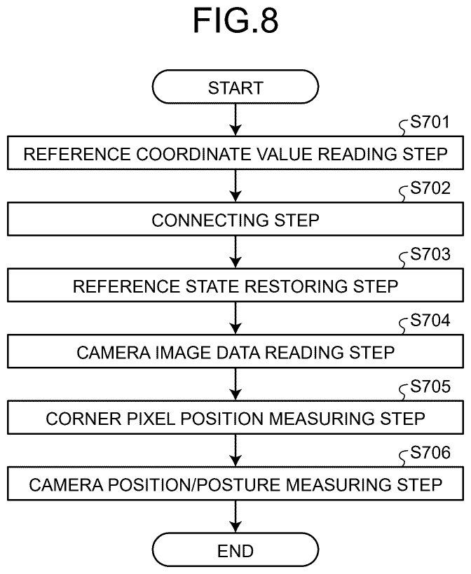

A procedure in a camera posture measuring process performed by the image processing apparatus 603 after the cameras are installed will be explained with reference to FIG. 8. FIG. 8 is a flowchart illustrating an example of the procedure in the camera posture measuring process.

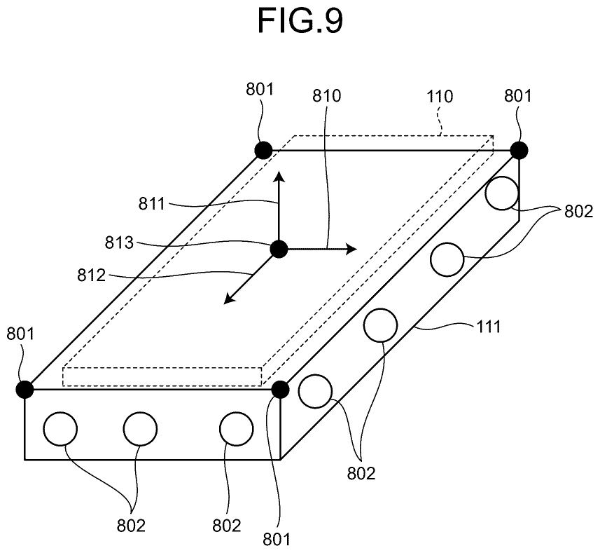

A reference coordinate value reading step S701 is a step for reading reference coordinate values from a file. The reference coordinate values will be explained, with reference to FIG. 9. The reference coordinate values are three-dimensional coordinate values of corner points 801 of the table 111 and three-dimensional coordinate values of the centers of spherical markers 802 and may be obtained from a blueprint of the table 111, for example. Although the coordinate axes may be determined arbitrarily, in the present example, an x-axis 810, a y-axis 811, and a z-axis 812 having the origin 813 at the center of the top face of the table are defined in such a manner that the x-axis 810 extends parallel to the width direction of the table 111, whereas the z-axis 812 extends parallel to the length (longitudinal) direction of the table 111.

A connecting step S702 is a step for opening an input stream of the camera image data sent from the IP camera 601 and the IP camera 602.

A reference state restoring step S703 is a step for making the table 111 horizontal. For example, the reference state restoring step S703 is executed as a result of a worker operating the radiation diagnosis apparatus 104. Although other parameters such as the height of the radiation (X-ray) tube 112 and the position of the tabletop 110 may arbitrarily be determined, it is necessary to ensure that the corner points 801 of the table 111 are not hidden in the camera image data.

A camera image data reading step S704 is a step for reading the camera image data from the input stream.

A corner pixel position measuring step S705 is a step for calculating the positions of the pixels corresponding to the corners of the table, from the camera image data. For example, the worker opens the camera image data by using an arbitrary image viewer capable of displaying the position of any pixel designated by a pointer, so as to visually find the pixels corresponding to the corners from a screen of the image viewer and to record the positions of the pixels into a file.

At a camera position/posture measuring step S706, camera parameters are estimated by using the pixel positions corresponding to the corners that were recorded in the file and the three-dimensional coordinate values of the corner points 801 included in the reference coordinate values. The camera parameters are three-dimensional coordinates of a pin hole obtained at the time of approximating each camera to a pin hole camera model, a direction vector of an optical axis, and direction vectors of two axes orthogonal to each other on the plane of an image sensor and correspond to the positions/postures of the cameras. As described in Non-Patent Literature 1 (Zhengyou Zhang. A flexible new technique for camera calibration. Pattern Analysis and Machine Intelligence, IEEE Transactions on, 22 (11): 1330-1334, 2000.), it is possible to transform the three-dimensional coordinates of the corner points 801 into pixel positions in the camera image data, by using the pin hole camera model. It is possible to measure the positions/postures of the IP camera 601 and the IP camera 602, by optimizing the values of the camera parameters, so as to minimize the distance between the pixel positions resulting from the transformation and the pixel positions obtained at the corner pixel position measuring step S705. The obtained camera parameters are saved in a file.

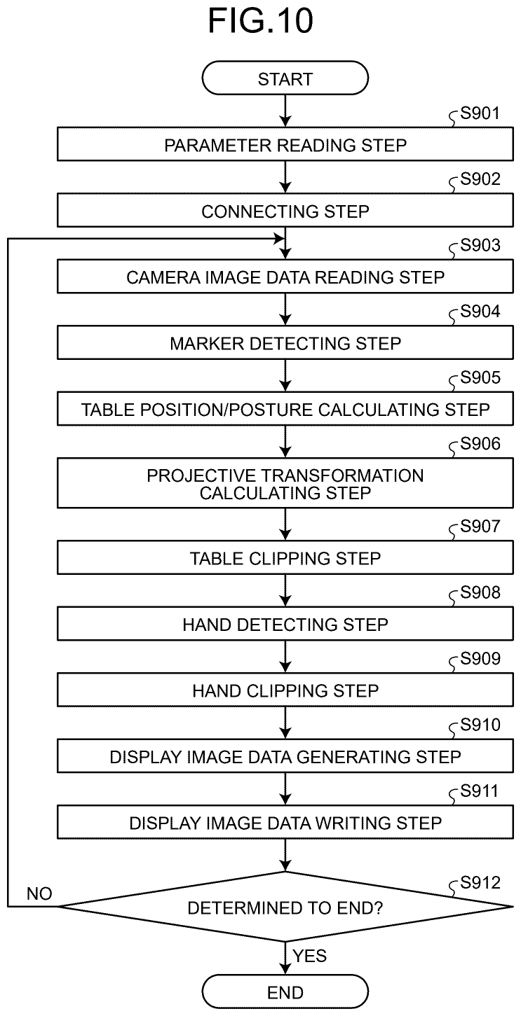

Next, a procedure in a display image data generating process performed by the image processing apparatus 603 will be explained, with reference to FIG. 10. FIG. 10 is a flowchart illustrating an example of the procedure in the display image data generating process.

A parameter reading step S901 is a step for reading the reference coordinate values and the camera parameters from the file.

A connecting step S902 is a step for opening an input stream of the camera image data sent from the IP camera 601 and the IP camera 602 and an output stream for sending the display image data to the display 604.

A camera image data reading step S903 is a step for reading the most recent camera image data from the input stream.

The marker detecting step S904 is a step for detecting center pixel positions of the markers 610 from the camera image data of the IP camera 601 and detecting center pixel positions of the markers 611 from the camera image data of the IP camera 602. Because the markers 610 and the markers 611 each have a spherical shape, the markers have circular shapes even when being imaged diagonally. For this reason, it is possible to accurately calculate the center coordinates from three points corresponding to the outer circumference of each marker. Although the markers 610 and the markers 611 may partially be hidden by a doctor, a nurse, or examination equipment present in the surroundings of the table in some situations, it is possible to perform the calculation at the later step as long as at least one each of the markers 610 and the markers 611 are included while three or more central pixel positions in total are obtained. If not, the display image data generating process is skipped for this piece of camera image data, and the process is performed starting with the next camera image data reading step S903.

A table position/posture calculating step S905 is a step for calculating the position/posture parameters of the table 111, on the basis of the center pixel positions of the markers 610 and the markers 611 and the three-dimensional coordinate values of the centers of the spherical markers 802 included in the reference coordinate values. The position/posture parameters of the table 111 are the coordinates of the origin 813 after the posture has changed and the coordinate axes (the x-axis 810, the y-axis 811, and the z-axis 812) after the posture has changed. Because the camera parameters are known from the camera position/posture measuring step S706, it is possible, as described in Non-Patent Literature 1, for example, to transform the three-dimensional coordinates of the centers of the spherical markers 802, into pixel positions in the camera image data. It is possible to calculate the position/posture of the table by optimizing the position/posture parameters of the table 111 so as to minimize the distance between the pixel positions resulting from the transformation and the center pixel positions of the markers 610 and the markers 611.

A projective transformation calculating step S906 is a step for calculating a parameter for a projective transformation to transform the pixel positions (hereinafter “input corner pixel positions”) corresponding to the corner points 801 in the camera image data, into ideal pixel positions (hereinafter, “output corner pixel positions”) using the longitudinal direction as the up-and-down directions. It is possible to obtain the input corner pixel positions from calculation based on the three-dimensional coordinate values of the corner points 801 and the position/posture parameters of the table 111. Although it is possible to arbitrarily select the output corner pixel positions, it is necessary to have the aspect ratio thereof match that of the rectangle formed by the corner points 801. It is possible to express the projective transformation by using Expression (2) presented below.

$${x}^{′} = \frac{{p}_{1} x + {p}_{2} y + {p}_{3}}{{p}_{7} x + {p}_{8} y + 1} , \qquad ( 2 )$$

$${y}^{′} = \frac{{p}_{4} x + {p}_{5} y + {p}_{6}}{{p}_{7} x + {p}_{8} y + 1} .$$

In Expression (2), “x” and “y” denote the position of the pixel in the camera image data, whereas “x′” and “y′” denote the position of the pixel in the image data in the output result. The items “p1” to “p8” represent projective transformation parameters. By substituting the four input corner pixel positions and the four output corner pixel positions for the variables “x”, “y”, “x′”, and “y′” in Expression (2), it is possible to obtain eight simultaneous equations using the projective transformation parameter as an unknown variable. By solving the simultaneous equations, it is possible to obtain the projective transformation parameter.

At a table clipping step S907 is a step for transforming the camera image data by carrying out the projective transformation in Expression (2) and further extracting a pixel region (hereinafter, “table extracted region”) including a rectangle obtained by connecting the output corner pixel positions together. The table extracted region is an example of the corrected image data. In the table extracted region, the table is shaped as a rectangle elongated lengthwise. In other words, the image processing apparatus 603 may generate the corrected image data (the table extracted region), by transforming the region including the placement region so as to be approximated to the rectangle elongated lengthwise. The size of the table extracted region may arbitrarily be selected, and it is also acceptable to have a surrounding part of the table included. In other words, the image processing apparatus 603 may extract a range corresponding to the rectangle obtained by connecting the output corner pixel positions together as the table extracted region, or may extract a range obtained by adding a surrounding region (a margin) to the rectangle as the table extracted region. It is possible to change the up-and-down direction of the table extracted region at the time of assigning the output corner pixel positions at the projective transformation calculating step S906.

A hand detecting step S908 is a step for detecting the hands of the patient 120 from the table extracted region. In other words, at the hand detecting step S908, the image processing apparatus 603 estimates regions representing the hands of the patient 120 and being included in the table extracted region. For example, the image processing apparatus 603 may detect the positions and the sizes of the hands, by applying a skeleton detection DNN to the table extracted region.

A hand clipping step S909 is a step for extracting pixel regions (hereinafter, “hand extracted regions”) centered on the hand positions, from the table extracted region. The image processing apparatus 603 may extract the regions determined to be the hands at the hand detecting step S908 as the hand extracted region, or may extract ranges obtained by adding a surrounding region (a margin) to each of the regions determined to be the hands as the hand extracted regions.

A display image data generating step S910 is a step for generating display image data, by combining together the camera image data, the table extracted region, and the hand extracted regions so as to be laid out as a single piece of image data. Because the plurality of cameras are provided, it is also acceptable to lay out, not all the different types of image data, but certain pieces of image data in a combination designated by the user or in a combination determined based on how good the image appears. Because a display image data writing step S911 and an end judging process S912 are the same as the display image data writing step S210 and the end judging process S212 presented in FIG. 3, explanations thereof will be omitted.

As explained above, the monitoring camera system 600 according to the second embodiment includes the IP camera 601, the IP camera 602, and the image processing apparatus 603. The IP camera 601 and the IP camera 602 are installed in the examination room and are configured to image the environment including the radiation diagnosis apparatus 104 with which it is possible to place the patient 120. The image processing apparatus 603 is configured to generate the display image data on the basis of the camera image data obtained by the image processing apparatus 603. Further, the image processing apparatus 603 is configured to cause the display 604 to display the display image data.

More specifically, on the basis of the markers attached to the table 111, the image processing apparatus 603 is configured to estimate the table 111, as the placement region corresponding to the region in which the patient 120 is placed in the camera image data. Further, the image processing apparatus 603 is configured to generate the corrected image data by correcting the camera image data in accordance with the estimated table 111. For example, the image processing apparatus 603 is configured to perform the projective transformation on the camera image data on the basis of the result of estimating the table 111 and to generate the table extracted region including the rectangle obtained by connecting the output corner pixel positions together, as the corrected image data. Further, the image processing apparatus 603 is configured to estimate the region representing the patient 120 and being included in the corrected image data. For example, the image processing apparatus 603 is configured to detect the positions and the sizes of the hands, by applying the skeleton detection DNN to the table extracted region. Subsequently, the image processing apparatus 603 is configured to generate the display image data on the basis of the corrected image data and the region representing the patient 120.

With this configuration, the monitoring camera system 600 according to the second embodiment is able to provide the assistance in efficiently monitoring the patient 120. For example, on the basis of the markers attached to the table 111, the monitoring camera system 600 is able to detect the table 111 of which the posture changes, from the camera image data, with an excellent level of precision. In other words, the monitoring camera system 600 is able to estimate the placement region corresponding to the region in which the patient 120 is placed, with an excellent level of precision.

Further, by arranging the shape of the table 111 in the image data to be a rectangle elongated lengthwise, the monitoring camera system 600 is able to enhance the level of precision in detecting the patient 120. In other words, by uniformizing the input data to the DNN as image data having a rectangular shape elongated lengthwise, it is possible to enhance the level of precision in the detection of the patient 120 performed by the DNN.

The example was explained above in which the table 111 is detected as the placement region. However, possible embodiments are not limited to this example. For instance, when markers similar to the markers 610 and the markers 611 are attached to the tabletop 110, it is possible to detect the tabletop 110 as a placement region, on the basis of a result of detecting the markers and the positions/postures of the IP camera 601 and the IP camera 602. Further, as mentioned earlier, the placement region may be the tabletop 110. In other words, the placement region may be estimated on the basis of a result of detecting the markers attached to either the tabletop 110 or the table 111 of the medical apparatus 10 and the position and the posture of the camera 30.

### Third Embodiment

In the second embodiment described above, the example was explained in which the table 111 in the camera image data is estimated, on the basis of the markers attached to the table 111. In a third embodiment, an example will be explained in which the table 111 in the camera image data is estimated, on the basis of control information of the table 111 in the radiation diagnosis apparatus 104.

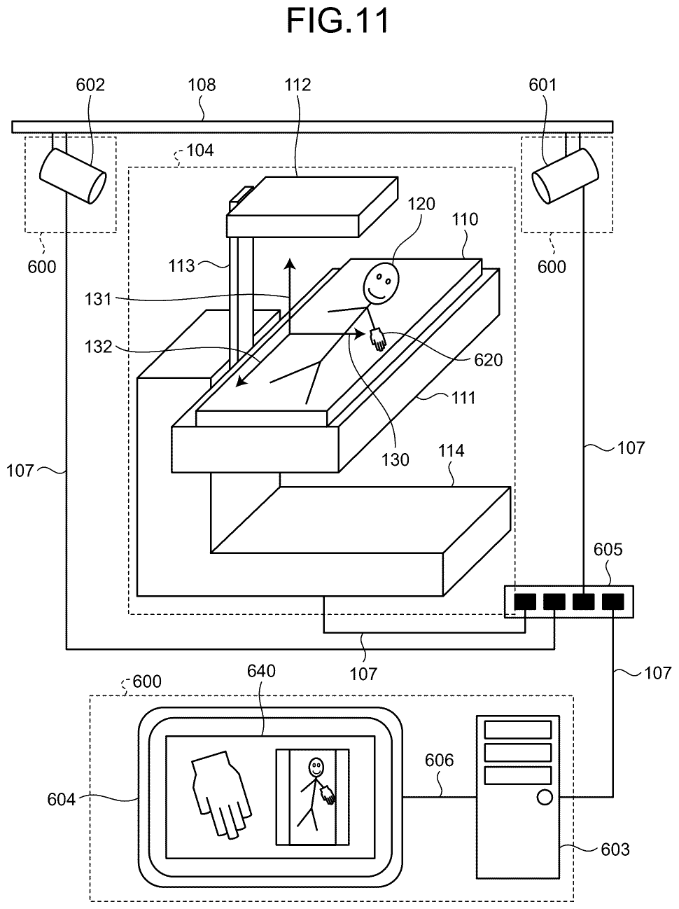

FIG. 11 is a diagram illustrating an example of the system 1 according to the third embodiment. The system 1 illustrated in FIG. 11 may basically be structured similarly to the system 1 illustrated in FIG. 7; however, the markers 610 and the markers 611 may be omitted. Further, the radiation diagnosis apparatus 104 illustrated in FIG. 11 is connected to the wired network hub 605 via a network cable 107, so as to be able to communicate with the monitoring camera system 600. With this configuration, the image processing apparatus 603 is able to make use of information such as a posture control command for the table 111 of the radiation diagnosis apparatus 104, a medical examination order, and the like.

From a blueprint of the radiation diagnosis apparatus 104 or the like, a rotation axis and the like of the table 111 are known. Accordingly, the image processing apparatus 603 is capable of directly calculating the position/posture of the table 111 from the posture control command for the table 111. For example, while omitting the marker detecting step S904 and the table position/posture calculating step S905 presented in FIG. 10, the image processing apparatus 603 is able to use a position/posture of the table calculated from the posture control command, at the projective transformation calculating step S906.

Further, at the display image data generating step S910 presented in FIG. 10, the image processing apparatus 603 is able to change the manner in which the different types of image data (e.g., the camera image data, the table extracted region, and the hand extracted region) are combined, in accordance with the medical examination order acquired from the radiation diagnosis apparatus 104.

As explained above, even when no marker is attached to the table 111 or when the markers attached to the table 111 are not appearing in the camera image data, the monitoring camera system 600 according to the third embodiment is able to provide assistance in efficiently monitoring the patient 120, by detecting the table 111 from the camera image data as the placement region and thereby making it possible to generate the display image data.

Although the example was explained in which the table 111 is detected as the placement region, possible embodiments are not limited to this example. For instance, when it is possible to use control information of the tabletop 110, it is possible to detect the tabletop 110 as a placement region, on the basis of the control information and the positions/postures of the IP camera 601 and the IP camera 602. In other words, the placement region may be estimated on the basis of the control information of either the tabletop 110 or the table 111 of the medical apparatus 10, as well as the position and the posture of the camera 30.

### Fourth Embodiment

In a fourth embodiment, a specific example of display control will be explained. Although the specific configuration of a monitoring camera system according to the fourth embodiment is not particularly limited, the configuration may be, in an example, the same as or similar to the monitoring camera system 100 illustrated in FIG. 2.

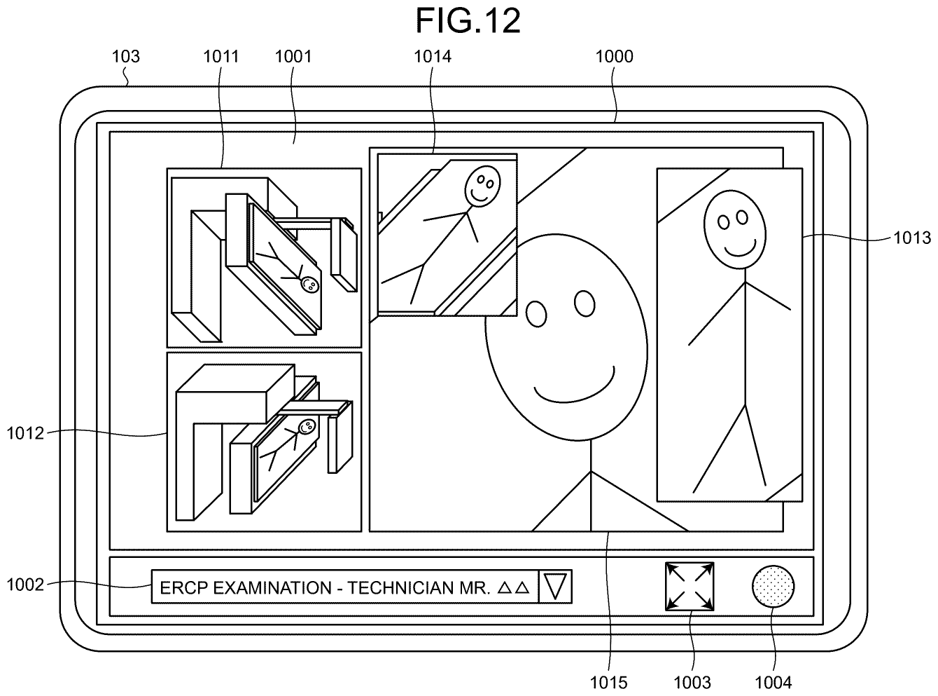

FIG. 12 illustrates a display example. For instance, the tablet PC 103 is configured to cause the display 140 to display a patient check screen 1000 illustrated in FIG. 12. The patient check screen 1000 is structured with an image data rendering region 1001, a layout selection list box 1002, a full screen display instruction button 1003, and a transition button 1004 used for transitioning onto a layout setting screen.

The image data rendering region 1001 is a region for rendering display image data sent from the image processing apparatus 102. The layout selection list box 1002 is used for selecting information (hereinafter, “layout information”) related to a structure of image data within the display image data. For example, the layout information is saved in the image processing apparatus 102 at the time of a product design or at the time of a registration on the layout setting screen (explained later) and is labeled in association with specifics of a medical examination (hereinafter, “examination specifics”) and/or a creator. For example, in FIG. 12, as a label combining examination specifics with a creator, “ERCP Examination-Technician: Mr. XX” is displayed in the layout selection list box 1002.

FIG. 12 illustrates an example of a user interface used for designating an object and a prescribed orientation at the time of generating the rotated image data described above. In other words, the tablet PC 103 is able to cause the display 140 to display the user interface used for designating the object and the prescribed orientation.

For example, the tablet PC 103 is able to receive an input of the examination specifics for the medical apparatus 10, via the layout selection list box 1002. In this situation, with respect to each item of examination specifics selectable from the layout selection list box 1002, an object and a prescribed orientation may be pre-set. In this manner, it is possible to designate an object and a prescribed orientation corresponding to a selected item of examination specifics. For example, as illustrated in FIG. 12, when “ERCP examination” is selected, it is possible to designate the “head” as the object and to designate the “up-and-down orientation” as the prescribed orientation. In other words, the tablet PC 103 is able to designate the object and the prescribed orientation, by receiving the input of the examination specifics for the medical apparatus 10, via the user interface.

Further, for example, the tablet PC 103 is able to receive an input of user information of the medical apparatus 10 via the layout selection list box 1002. In this situation, with respect to each piece of user information selectable from the layout selection list box 1002, an object and a prescribed orientation may be pre-set. In this manner, it is possible to designate an object and a prescribed orientation corresponding to a selected piece of user information. For example, when “Technician: Mr. XX” is selected as illustrated in FIG. 12, it is possible to designate the “head” as the object and to designate the “up-and-down orientation” as the prescribed orientation. In other words, the tablet PC 103 is able to designate the object and the prescribed orientation, by receiving the input of the user information of the medical apparatus 10, via the user interface.

In FIG. 12, within the layout selection list box 1002, the examination specifics and the user information are displayed in combination. In other words, the tablet PC 103 is able to designate the object and the prescribed orientation by receiving the input of the examination specifics and the user information of the medical apparatus 10 via the user interface. The tablet PC 103 may be configured so that it is possible to input the examination specifics and the user information separately or so that it is possible to input only one of the two.

The label of the layout information selected from the layout selection list box 1002 is sent from the tablet PC 103 to the image processing apparatus 102, so that the structure of the image data within the display image data is changed. For example, according to a layout corresponding to the “ERCP Examination-Technician: Mr. XX”, camera image data 1011, camera image data 1012 taken from a different direction, a tabletop extracted region 1013 and a tabletop extracted region 1014 rendering the surroundings in mutually-different manners and having mutually-different angles, and an enlarged head extracted region 1015 are laid out in the display image data. It is also possible to make a copy of the same image data and to lay out the copied data with a different magnification ratio or a different rotation angle. It is also possible to lay out a plurality of pieces of image data in an overlapping manner. However, image data (e.g., the tabletop extracted region or the head extracted region) used for checking on the patient 120 is laid out after the image data is rotated so that the head-to-toe direction of the patient 120 becomes close to the up-and-down direction of the patient check screen 1000. In other words, the tabletop extracted region and the head extracted region are each laid out in an orientation conforming to an upright posture. Further, to decrease computation loads in the rotating process, it is also acceptable to rotate the image data only by a predetermined rotation angle, although there may be a large difference between the head-to-toe direction and the up-and-down direction of the patient check screen 1000. For example, it is acceptable to rotate the image data by 90 degrees, 180 degrees, or 270 degrees, so as to minimize the difference between the head-to-toe direction and the up-and-down direction of the patient check screen 1000.

In other words, the image processing apparatus 102 is configured to specify, from the camera image data, the object such as a site (body site) of the patient 120 or an apparatus structure of the radiation diagnosis apparatus 104 and to further generate the rotated image data obtained by rotating the camera image data so that the specified object is positioned in the prescribed orientation. After that, the tablet PC 103 causes the display 140 to display the display image data including the rotated image data.

For example, when the object is the head of the patient 120, the image processing apparatus 102 is configured to generate rotated image data obtained by rotating the image data so that the head of the patient 120 comes to the top, as indicated with the head extracted region 1015 in FIG. 12. In other words, when the object is the head of the patient 120, the image processing apparatus 102 is configured to generate the rotated image data obtained by rotating the image data so that the head becomes upright.

Further, for example, when the object is the torso of the patient 120, the image processing apparatus 102 is configured to generate rotated image data obtained by rotating the image data so that the torso of the patient 120 comes to the top. In other words, when the object is the torso of the patient 120, the image processing apparatus 102 is configured to generate the rotated image data obtained by rotating the image data so that the torso is upright.

Further, for example, when the object is a placement region of the tabletop 110, the table 111, or the like, the image processing apparatus 102 is configured to generate rotated image data obtained by rotating the image data so that the long axis of the placement region corresponds to the up-and-down direction. For example, as indicated with the tabletop extracted region 1013 in FIG. 12, the rotated image data is generated by rotating the image data so that the centerline orientation of the tabletop 110 corresponds to the up-and-down direction.

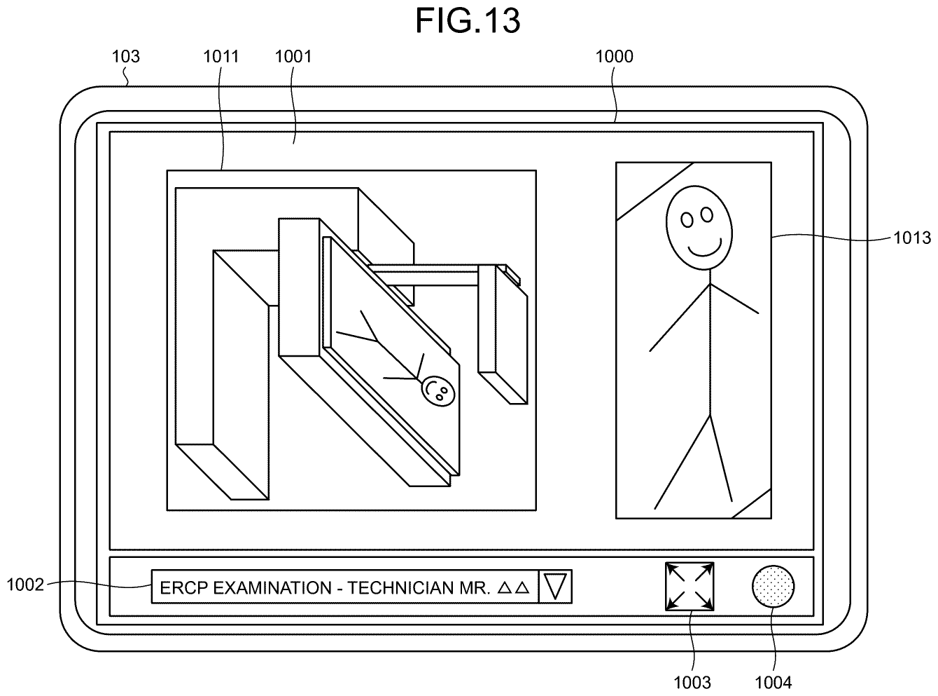

The display image data illustrated in FIG. 12 is merely an example, and it is possible to apply various types of modifications thereto. For example, as illustrated in FIG. 13, it is also acceptable to lay out, in the display image data, only the camera image data 1011 and the tabletop extracted region 1013 that has been rotated so that the crown comes to the top. By laying out various types of images within the display image data, it is possible to present image data at an angle or in a range desired by the operator. In contrast, by decreasing the number of images laid out in the display image data, it is possible to display each of the images in a larger size and in an easy-to-see manner.

The full screen display instruction button 1003 is a button used for inputting an instruction that the image data rendering region 1001 should be enlarged to a full screen. The transition button 1004 for transitioning onto the layout setting screen is a button used for inputting an instruction that the patient check screen 1000 should be transitioned into the layout setting screen (explained later). The display controlling function of the tablet PC 103 is configured to switch, as appropriate, the display on the patient check screen 1000, in response to the input operations received via the full screen display instruction button 1003 and the transition button 1004.

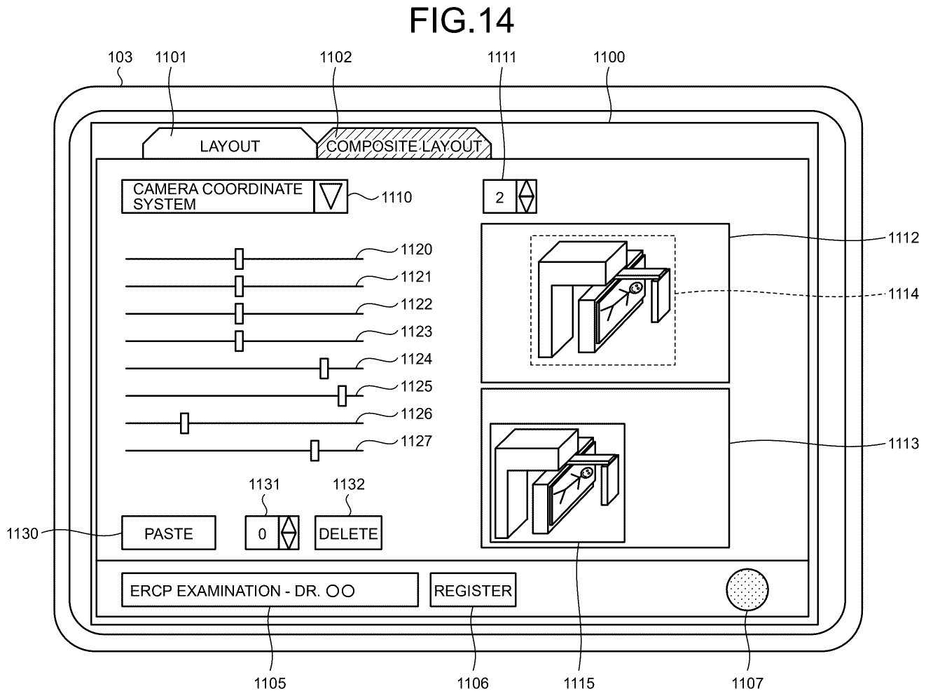

Next, the layout setting screen will be explained. FIG. 14 is a drawing illustrating an example of the layout setting screen according to the fourth embodiment.

For example, a layout setting screen 1100 includes a layout tab 1101, a composite layout tab 1102, a layout name input text box 1105, a layout information registration button 1106, and a transition button 1107 for transitioning onto the patient check screen. When one of the layout tab 1101 and the composite layout tab 1102 is selected, the layout of user interface component parts (hereinafter, “UI component parts”) such as the buttons, the list boxes, and the like is changed.

When the layout tab 1101 is selected, for example, the screen includes a coordinate system selection list box 1110, a camera number selection spin control element 1111, a camera window 1112, a layout window 1113, slider control elements 1120 to 1127, a paste instruction button 1130, a pasted region number selection spin control element 1131, and a delete button 1132. The coordinate system selection list box 1110 and the spin control element 1111 are used for selecting a coordinate system and a camera number for the image data to be displayed in the camera window 1112.

In the coordinate system selection list box 1110, when the “camera coordinate system” is selected, the camera window 1112 displays the camera image data so that the center pixel is aligned with the center of the camera window 1112. With respect to the image data to be displayed in the camera window 1112, it is possible to adjust a rotation amount, a magnification ratio, a width direction shift distance, and a length direction shift distance, by using the slider control elements 1120 to 1123, respectively. Although it is possible to arbitrarily determine the scale intervals of the slider control elements 1120 to 1123, because the image data rotation imposes a large computation load, it is acceptable to discretize the scale at 90-degree intervals, such as 0 degrees, 90 degrees, 180 degrees, and 270 degrees.

The camera window 1112 displays a rectangle 1114 representing a cutout region while being superimposed over the image data. Because the rectangle 1114 representing the cutout region is independent of the image data, the rectangle 1114 is not affected by geometric transformations designated by the slider control elements 1120 to 1123. It is possible to adjust the width and the length of the rectangle 1114 representing the cutout region, by using the slider control elements 1124 and 1125.

After the paste instruction button 1130 is pressed, the image data included in the rectangle 1114 representing the cutout region is displayed in the layout window 1113, as indicated as a pasted region 1115 in FIG. 14. It is possible to adjust the position of the pasted region 1115 in the layout window 1113, by using the slider control elements 1126 and 1127.

When the paste instruction button 1130 is pressed, the data input through the coordinate system selection list box 1110, the spin control element 1111, the slider control elements 1120 to 1127, and the like is recorded into a memory included in the tablet PC 103, together with a number identifying the pasted region. A set made up of these recorded pieces of data is referred to as layout information. By selecting a pasted region number while using the spin control element 1131 and pressing the delete button 1132, it is possible to delete the data associated with the pasted region number from the records.

Next, an example will be explained in which, from the coordinate system selection list box 1110, a coordinate system based on characteristics of an imaged subject (e.g., the patient 120, a body site of the patient 120, the tabletop 110, the table 111, etc.) is selected, instead of the camera coordinate system.

The coordinate system selection list box 1110 is an example of a user interface used for designating an object and a prescribed orientation. Via the coordinate system selection list box 1110, the tablet PC 103 is able to receive an input designating a body site (e.g., the head or the torso) of the patient. In other words, the tablet PC 103 is able to designate the object and the prescribed orientation, by receiving the input designating the body site of the patient, via the user interface. Also, via the coordinate system selection list box 1110, the tablet PC 103 is able to receive an input of information about the placement region (e.g., the tabletop 110 or the table 111). In other words, the tablet PC 103 is able to designate the object and the prescribed orientation, by receiving the input of the information about the placement region, via the user interface.

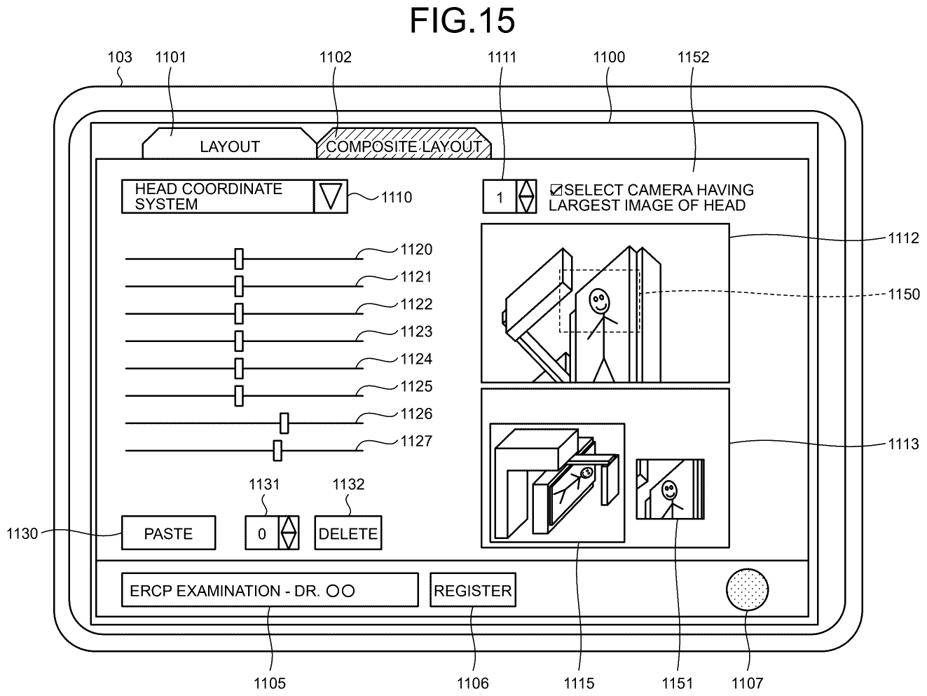

FIG. 15 is a drawing illustrating an example of selecting a head coordinate system being one of the coordinate systems based on characteristics of an imaged subject. The head coordinate system is a coordinate system of the head extracted region obtained at the head clipping step S209 and uses the center of the head as the origin and uses the crown direction as a y-axis (the coordinate axis in the length direction of the head extracted region). However, the definition of the head coordinate system described herein is not strict. For example, from between the length-direction axis and the width-direction axis of the camera image, whichever is closer to the crown direction may be defined as the y-axis of the head coordinate system. In that situation, by limiting the rotation angles selectable with the slider control element 1120 to 0 degrees, 90 degrees, 180 degrees, and 270 degrees, it is possible to decrease computation loads in the image rotating process. Alternatively, it is also acceptable to use, instead, a direction close to the crown direction such as the centerline orientation of the tabletop.

When the “head coordinate system” is selected via the coordinate system selection list box 1110, the camera window 1112 displays a camera image that has been rotated so that the head is upright. Similarly to the examples of other coordinate systems, after the paste instruction button 1130 is entered, the image included in a rectangle 1150 representing a cutout region is copied as a pasted region 1151, according to adjustments made via the slider control elements 1120 to 1127.

When the “head coordinate system” is selected, a camera selection condition checkbox 1152 is added to the inside of the screen. Because the head coordinate system is a coordinate system determined depending on the imaged subject, if the imaged subject is included in the image data, the definition may be determined regardless of the camera number. When the camera selection condition checkbox 1152 is checked, the camera number selected via the spin control element 1111 is ignored, so as to select a camera number corresponding to the largest head size calculated at the head detecting step S207. Although the head may be imaged small depending on the posture of the tabletop, this function enables selecting, as the pasted region 1151, the camera image rendering the head in the largest size among all the cameras. After the paste instruction button 1130 is pressed, an input value received via the camera selection condition checkbox 1152 is also recorded as the layout information, together with the input data from the other UI component parts.

When the layout information registration button 1106 is pressed after all the pasted regions are determined, the layout information is registered into the image processing apparatus 102, together with the label input to the text box 1105. When the label is selected in the layout selection list box 1002 on the patient check screen 1000, display image data is to be generated by taking the head coordinate system and the size of the head into consideration.

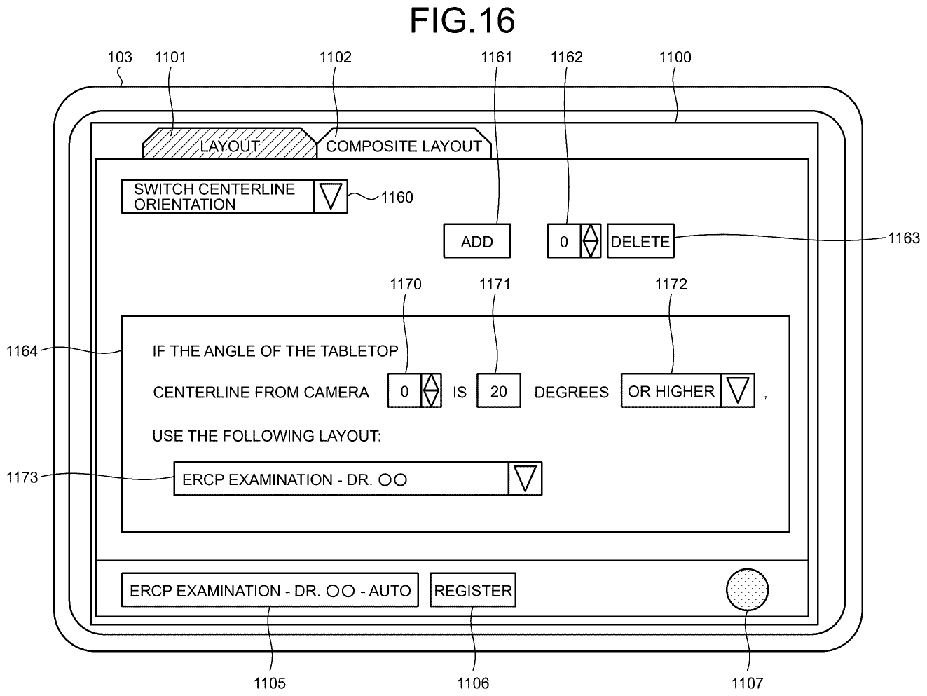

Next, an example in which the composite layout tab 1102 has been selected will be explained. FIG. 16 is a drawing illustrating an example of a screen corresponding to the situation where the composite layout tab 1102 has been selected. A composite layout switches among a plurality of layouts that have already been registered according to a rule (hereinafter, “layout selection rule”) that uses the characteristics of the imaged subject. The screen corresponding to the composite layout tab 1102 includes a rule selection list box 1160, a rule addition button 1161, a rule number spin control element 1162, a rule deletion button 1163, and a rule detail input section 1164.

The composite layout illustrated in FIG. 16 is an example of a user interface used for designating an object and a prescribed orientation. By using the complex layout, the tablet PC 103 is able to receive an input of a condition (the layout selection rule) related to an object included in the camera image data. In other words, the tablet PC 103 is able to designate the object and the prescribed orientation, by receiving the input of the condition related to the object, via the user interface.

In the rule detail input section 1164, UI component parts are laid out in accordance with the layout selection rule selected from the rule selection list box 1160. When the rule “Switch the centerline orientation” is selected from the rule selection list box 1160, the rule detail input section 1164 includes a camera number input spin control element 1170, a tabletop centerline angle input text box 1171, a tabletop centerline angle condition selection list box 1172, and a layout selection list box 1173.

Information obtained from the UI component parts in the rule detail input section 1164 indicates a layout selection rule. Let us express a number input via the spin control element 1170 as “A”, an angle input to the text box 1171 as “B”, an angle condition in the tabletop centerline angle condition selection list box 1172 as “C”, and a layout in the layout selection list box 1173 as “D”. In this situation, the layout selection rule is defined as “The angle of the tabletop centerline is calculated from the camera image data numbered A and is compared with B so that, if the comparison result satisfies angle condition C, layout D is to be selected”.

When the rule addition button 1161 is pressed after data has been input in the rule detail input section 1164, the layout selection rule is recorded into a memory included in the tablet PC 103. By selecting a number identifying a layout selection rule via the spin control element 1162, it is possible to delete the record of the selected layout rule by using the rule deletion button 1163.

When the composite layout is used, a set of the recorded layout selection rules is handled as the layout information. As a result of pressing the layout information registration button 1106, the layout information is to be registered into the image processing apparatus 102, together with a label input to the text box 1105.

As explained above, the image processing apparatus 102 according to the fourth embodiment is configured to specify the object from the camera image data and to generate the rotated image data by rotating the camera image data so that the specified object is positioned in the specific orientation. Further, the tablet PC 103 is configured to cause the display 140 to display the display image data including the rotated image data. With this configuration, the monitoring camera system 100 according to the fourth embodiment is able to provide the assistance in efficiently monitoring the patient 120. In other words, the monitoring camera system 100 is able to realize the display after rotating the image data into the orientation determined on the basis of the characteristics of a tracked object such as the head, the tabletop, or the like. It is therefore possible to assist the operator in monitoring the tracked object.

In the above embodiments, the radiation diagnosis apparatus 104 was explained as an example of the medical apparatus with which it is possible to place a patient. However, possible embodiments are not limited to this example. The present disclosure is similarly applicable to other medical apparatuses which includes a tabletop, a table, and/or the like and with which it is possible to place a patient. Examples of such medical apparatuses include medical image diagnosis apparatuses such as an X-ray CT apparatus and an MRI apparatus; and treatment apparatuses such as a radiation treatment apparatus. When the applied apparatus includes a gantry like an X-ray CT apparatus or an MRI apparatus, the camera 30 may be provided for the gantry.

The term “processor” used in the above explanations denotes, for example, a Central Processing Unit (CPU), a Graphics Processing Unit (GPU), or circuitry such as an Application Specific Integrated Circuit (ASIC) or a programmable logic device (e.g., a Simple Programmable Logic Device (SPLD), a Complex Programmable Logic Device (CPLD), or a Field Programmable Gate Array (FPGA)). When one or more processors are each a CPU, for example, the processors realize functions by reading and executing programs saved in storage circuitry. In contrast, when the one or more processors are each an ASIC, for example, instead of having the programs saved in the storage circuitry, the functions are directly incorporated in the circuitry of the processors as logic circuitry. The processors in the embodiments do not each necessarily need to be structured as a single piece of circuitry. It is also acceptable to structure one processor by combining together a plurality of pieces of independent circuitry so as to realize the functions thereof. Further, it is also acceptable to integrate two or more of the constituent elements in the drawings into one processor so as to realize the functions thereof.

The constituent elements of the apparatuses according to the above embodiments are based on functional concepts. Thus, it is not necessarily required to physically configure the constituent elements as indicated in the drawings. In other words, specific modes of distribution and integration of the apparatuses are not limited to those illustrated in the drawings. It is acceptable to functionally or physically distribute or integrate all or a part of the apparatuses in any arbitrary units, depending on various loads and the status of use. Further, all or an arbitrary part of the processing functions performed by the apparatuses may be realized by a CPU and a program analyzed and executed by the CPU or may be realized as hardware using wired logic.

Further, the methods explained in the above embodiments may be realized by causing a computer such as a personal computer or a workstation to execute a program prepared in advance. The program may be distributed via a network such as the Internet. Further, the medical information processing program may be recorded on a non-transitory computer-readable recording medium such as a hard disk, a flexible disc (FD), Compact Disc Read-Only Memory (CD-ROM), a Magneto-Optical (MO) disc, a Digital Versatile Disc (DVD), or the like, so as to be executed as being read from the recording medium by a computer.

According to at least one aspect of the embodiments described above, it is possible to provide the assistance in efficiently monitoring the patient.

In relation to the above embodiments, the following notes are presented as certain aspects and selective characteristics of the present disclosure:

### Note 1:

A monitoring camera system includes:
an image processing unit configured to acquire camera image data obtained by a camera installed in an examination room and configured to image an environment including a medical apparatus with which it is possible to place an examined subject and to generate display image data on a basis of the camera image data; and
a display controlling unit configured to cause a display to display the display image data.

The image processing unit is configured:
to estimate a placement region corresponding to a region in which the examined subject is placed in the camera image data;
to generate corrected image data obtained by correcting the camera image data in accordance with the placement region;
to estimate a region representing the examined subject and being included in the corrected image data; and
to generate the display image data on the basis of the corrected image data and the region representing the examined subject.

### Note 2:

The placement region may be either a tabletop or a couchtop of the medical apparatus.

### Note 3:

The placement region may be either a table or a couch of the medical apparatus.

### Note 4:

The placement region may be estimated by a deep neural network.

### Note 5:

The placement region may be estimated on the basis of a result of detecting a marker attached to one of a tabletop, a couchtop, a table, and a couch of the medical apparatus, as well as a position and a posture of the camera.

### Note 6:

The placement region may be estimated on the basis of control information of one of a tabletop, a couchtop, a table, and a couch of the medical apparatus, as well as a position and a posture of the camera.

### Note 7:

The image processing unit may be configured to generate the corrected image data, by rotating a region including the placement region so that a centerline of the placement region corresponds to an up-and-down direction.

### Note 8:

The image processing unit may be configured to generate the corrected image data by transforming a region including the placement region so as to approximate a rectangle elongated lengthwise.

### Note 9:

A rotation angle of the rotation may be determined on the basis of an orientation of a side of a polygon enclosing the placement region.

### Note 10:

A rotation angle of the rotation may be determined on the basis of a positional difference of a physical object included in common to a plurality of pieces of the camera image data taken at mutually-different times.

### Note 11:

A monitoring camera system includes:
an image processing unit configured to acquire camera image data obtained by a camera installed in an examination room and configured to image an environment including a medical apparatus with which it is possible to place an examined subject and to generate display image data on a basis of the camera image data; and
a display controlling unit configured to cause a display to display the display image data.

The image processing unit is configured:
to specify an object from the camera image data; and
to generate rotated image data obtained by rotating the camera image data so that the specified object is positioned in a prescribed orientation.

The display controlling unit is configured to cause the display to display the display image data including the rotated image data.

### Note 12:

The object may be the head of the examined subject, and the prescribed orientation may denote being oriented so as to come to a top.

### Note 13:

The object may be the torso of the examined subject, and the prescribed orientation may denote being oriented so as to come to a top.

### Note 14:

The object may be a placement region corresponding to a region in which the examined subject is placed, and
the prescribed orientation may be an orientation to have a long axis of the placement region extend up and down.

### Note 15:

The display controlling unit may be configured to cause the display to display a user interface used for designating the object and the prescribed orientation.

### Note 16:

The display controlling unit may be configured to designate the object and the prescribed orientation, by receiving an input of examination specifics for the medical apparatus via the user interface.

### Note 17:

The display controlling unit may be configured to designate the object and the prescribed orientation, by receiving an input of user information of the medical apparatus, via the user interface.

### Note 18:

The display controlling unit may be configured to designate the object and the prescribed orientation, by receiving an input of a body site of the examined subject, via the user interface.

### Note 19:

The display controlling unit may be configured to designate the object and the prescribed orientation, by receiving, via the user interface, an input of information about a placement region corresponding to a region in which the examined subject is placed.

### Note 20:

The display controlling unit may be configured to designate the object and the prescribed orientation, by receiving, via the user interface, an input of a condition related to the object included in the camera image data.

### Note 21:

A radiation imaging system includes:
a radiation diagnosis apparatus with which it is possible to place an examined subject;
an image processing unit configured to acquire camera image data obtained by a camera installed in an examination room and configured to image an environment including a medical apparatus with which it is possible to place an examined subject and to generate display image data on a basis of the camera image data; and
a display controlling unit configured to cause a display to display the display image data.

The image processing unit is configured:
to estimate a placement region corresponding to a region in which the examined subject is placed in the camera image data;
to generate corrected image data obtained by correcting the camera image data in accordance with the placement region;
to estimate a region representing the examined subject and being included in the corrected image data; and
to generate the display image data on the basis of the corrected image data and the region representing the examined subject.

### Note 22:

A radiation imaging system includes:
a radiation diagnosis apparatus with which it is possible to place an examined subject;
an image processing unit configured to acquire camera image data obtained by a camera installed in an examination room and configured to image an environment including a medical apparatus with which it is possible to place an examined subject and to generate display image data on a basis of the camera image data; and
a display controlling unit configured to cause a display to display the display image data.

The image processing unit is configured:
to specify an object from the camera image data;
to generate rotated image data obtained by rotating the camera image data so that the specified object is positioned in a prescribed orientation; and
to cause the display to display the display image data including the rotated image data.

### Note 23:

A method includes:
acquiring camera image data obtained by a camera installed in an examination room and configured to image an environment including a medical apparatus with which it is possible to place an examined subject;
generating display image data on a basis of the camera image data; and
causing a display to display the display image data.

The method includes:
estimating a placement region corresponding to a region in which the examined subject is placed in the camera image data;
generating corrected image data obtained by correcting the camera image data in accordance with the placement region;
estimating a region representing the examined subject and being included in the corrected image data; and
generating the display image data on the basis of the corrected image data and the region representing the examined subject.

### Note 24:

A method includes:
acquiring camera image data obtained by a camera installed in an examination room and configured to image an environment including a medical apparatus with which it is possible to place an examined subject;
generating display image data on a basis of the camera image data; and
causing a display to display the display image data.

The method includes:
specifying an object from the camera image data;
generating rotated image data obtained by rotating the camera image data so that the specified object is positioned in a prescribed orientation; and
the display controlling unit being configured to cause the display to display the display image data including the rotated image data.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A monitoring camera system comprising processing circuitry configured: to acquire camera image data obtained by a camera installed in an examination room and configured to image an environment including a medical apparatus with which it is possible to place an examined subject; to generate display image data on a basis of the camera image data; and to cause a display to display the display image data, wherein
the processing circuitry is configured
to estimate a placement region corresponding to a region in which the examined subject is placed in the camera image data,
to generate corrected image data obtained by correcting the camera image data in accordance with the placement region,
to estimate a region representing the examined subject and being included in the corrected image data, and
to generate the display image data on a basis of the corrected image data and the region representing the examined subject.

2. The monitoring camera system according to claim 1, wherein the placement region is either a tabletop or a couchtop of the medical apparatus or a table or a couch of the medical apparatus.

3. The monitoring camera system according to claim 1, wherein the placement region is estimated by a deep neural network.

4. The monitoring camera system according to claim 1, wherein the placement region is estimated on a basis of a result of detecting a marker attached to one of a tabletop, a couchtop, a table, and a couch of the medical apparatus, as well as a position and a posture of the camera.

5. The monitoring camera system according to claim 1, wherein the placement region is estimated on a basis of control information of one of a tabletop, a couchtop, a table, and a couch of the medical apparatus, as well as a position and a posture of the camera.

6. The monitoring camera system according to claim 1, wherein the processing circuitry is configured to generate the corrected image data, by rotating a region including the placement region so that a centerline of the placement region corresponds to an up-and-down direction.

7. The monitoring camera system according to claim 1, wherein the processing circuitry is configured to generate the corrected image data by transforming a region including the placement region so as to approximate a rectangle elongated lengthwise.

8. The monitoring camera system according to claim 6, wherein a rotation angle of the rotation is determined on a basis of an orientation of a side of a polygon enclosing the placement region or a positional difference of a physical object included in common to a plurality of pieces of the camera image data taken at mutually-different times.

9. A monitoring camera system comprising processing circuitry configured: to acquire camera image data obtained by a camera installed in an examination room and configured to image an environment including a medical apparatus with which it is possible to place an examined subject; to generate display image data on a basis of the camera image data; and to cause a display to display the display image data, wherein
the processing circuitry is configured:
to specify an object from the camera image data,
to generate rotated image data obtained by rotating the camera image data so that the specified object is positioned in a prescribed orientation, and
to cause the display to display the display image data including the rotated image data.

10. The monitoring camera system according to claim 9, wherein
the object is a head or a torso of the examined subject, and
the prescribed orientation denotes being oriented so as to come to a top.

11. The monitoring camera system according to claim 9, wherein
the object is a placement region corresponding to a region in which the examined subject is placed, and
the prescribed orientation is an orientation to have a long axis of the placement region extend up and down.

12. The monitoring camera system according to claim 9, wherein the processing circuitry is configured to cause the display to display a user interface used for designating the object and the prescribed orientation.

13. The monitoring camera system according to claim 12, wherein the processing circuitry is configured to designate the object and the prescribed orientation, by receiving an input of: examination specifics for the medical apparatus; user information of the medical apparatus; a body site of the examined subject; or information about a placement region corresponding to a region in which the examined subject is placed, via the user interface.

14. The monitoring camera system according to claim 12, wherein the processing circuitry is configured to designate the object and the prescribed orientation, by receiving, via the user interface, an input of a condition related to the object included in the camera image data.

15. A radiation imaging system comprising:
a radiation diagnosis apparatus with which it is possible to place the examined subject; and
the monitoring camera system according to claim 1.

16. A radiation imaging system comprising:
a radiation diagnosis apparatus with which it is possible to place the examined subject; and
the monitoring camera system according to claim 9.

17. A method that includes:
acquiring camera image data obtained by a camera installed in an examination room and configured to image an environment including a medical apparatus with which it is possible to place an examined subject;
generating display image data on a basis of the camera image data; and
causing a display to display the display image data, wherein
the method comprises:
estimating a placement region corresponding to a region in which the examined subject is placed in the camera image data,
generating corrected image data obtained by correcting the camera image data in accordance with the placement region,
estimating a region representing the examined subject and being included in the corrected image data, and
generating the display image data on a basis of the corrected image data and the region representing the examined subject.

18. A method that includes:
acquiring camera image data obtained by a camera installed in an examination room and configured to image an environment including a medical apparatus with which it is possible to place an examined subject;
generating display image data on a basis of the camera image data; and
causing a display to display the display image data, wherein
the method comprises:
specifying an object from the camera image data,
generating rotated image data obtained by rotating the camera image data so that the specified object is positioned in a prescribed orientation, and
causing the display to display the display image data including the rotated image data.
